(19) United States
(12) Patent Application Publication
(10) Pub. No.: US 2004/0104268 A1
(43) Pub. Date: Jun. 3, 2004

(54) Plug in credit card reader module for wireless cellular phone verifications

(76) Inventor: Kenneth Stephen Bailey, Longboat Key, FL (US)

Correspondence Address: Kenneth S. Bailey, Suite 207, 4134 Gulf of Mexico Drive, Longboat Key, FL, 34228, US

(21) Appl. No.: 10/207,730

(22) Filed: Jul. 30, 2002

(51) Int. Cl. G06K 7/00

(52) U.S. Cl. 235/439

(57) ABSTRACT

A method for converting a standard, consumer, hand held, cellular telephone into a hand held, point of sale, (POS) credit card terminal, utilizing an attachment module which plugs into the data port on the bottom or external RS-232 port of the cellular phone is described herein. The Module is comprised of: a reinforced plastic enclosure molded to the contour of the cellular phone; an internal printed circuit board containing a micro-processor unit, a memory chip, an I/R interface chip, I/R diodes; a credit card reader head that has been modified to reduce the size of the reader head thickness; a smart card reader assembly; a barcode reader and; an electronic fingerprint reader interface.

### BACKGROUND OF THE INVENTION

This invention relates to the processing of credit card transactions in the field, where ordinarily a credit card can only be processed by manually sliding a credit card imprinter device across the card while the card is held inside a mechanical device, then telephoning the raised credit card information manually to a customer service representative at a credit-card processing center, then manually recording an authorization code recited over the phone orally by the person processing the transaction (assuming the card is not canceled, stolen, or over its' spending limit). Not only is this procedure inconvenient and time consuming (especially in the event of a busy line, being placed on hold, or the customer service rep's terminal being down), it creates increased losses due to fraud, for the credit card issuing companies and at the same time costs the merchant accepting payments in the field, additional processing fees due to the inherent and perceived risks of potential fraud. When the same credit card is slid though or inserted into an electronic credit card reader device or smartcard mechanism, and the card is magnetically or internally read out, as in the case in most retail stores and restaurants, the credit card fraud factor is reduced, especially since at the time the credit card is swiped or read electronically, the card holder is almost always present at the time of the transaction. The instances of credit card fraud when the raised numbers on the front of the credit card a merely copied down mechanically and not electronically processed are a calculated risk for both the merchant accepting the card, (since there is no real-time verification), as well as the credit card processing company, giving the authorization. While the card may be valid and good for the purchase amount, the person utilizing the card number to effect the purchase, may not be authorized to do so. This practice creates charge backs for the Merchant, and ultimately costs the processor in terms of disputed card purchases, and the attendant labor costs in resolving disputes between the card holder and the Merchant accepting the card.

Earlier methods at solving this problem were kluge at best, and involved the slipshod melding of technologies at a great expense in terms of hardware requirements. One such solution developed by Hypercom, a publicly traded Company, involves the marriage of a standard off the shelf Verifone credit card reader device and a conventional hand-held phone, neatly packaged in a large briefcase, which is all battery powered. This system costs approximately $1,500.00 per unit and is not very portable in terms of customer convenience. No Company found offers a device that is usable on an as needed basis by merely plugging in an add on module into an off the shelf cellular phone's external data port, and removing the plug in module, when no credit card transactions are being processed.

The credit card data is considered to be at risk to potential pirating or scanning during the over the air transmission phase of wireless credit card processing. The Hypercom method, for one, does not use a US Government approved secure encryption method at the present time. This offers customers and credit card agencies virtually no security for these over the air credit card verifications and may over the long term, actually contribute to increasing credit card fraud on a large scale basis. The present invention addresses the need for the over the air security, required by all Bankcard issuing agencies in the United States, by utilizing a US Government approved, Triple Digital Encryption Standard Algorithmic encryption couple to a Digital Signature Key. This is the same level of encryption that is presently used by Banking institutions for wire line Banking transactions and is the same level of security currently utilized by the US Department of Defense and for matters involving US National Security. A physical security measure of this invention is to encapsulate the TDES—ASIC encryption I/C in hardened epoxy resin, to thwart any efforts to internally compromise the encryption I/C and gain access to the internal encryption keys, which are generated by a random key generation algorithm on each and every transaction. This then affords the same level of security as most ATM machines mounted in the wall of the Bank building.

In today's fast paced world, the efficiency and speed of the computer process is a significant factor in any transaction either financial in nature or in just terms of providing the consumer a time saving advantage. The earlier processes involving systems developed by Hypercom and others, typically involve nearly a full minute to complete the verification and processing of each credit card-transaction. Utilizing the technologies described herein, reduces the processing time to a few seconds for each transaction. This benefit adds to customer satisfaction and creates a much more secure and desirable product overall.

### DESCRIPTION OF THE PREFERRED EMBODIMENT

The plug in module is designed to be plugged into the external port of the most popular, cellular, hand-held phones, on the market throughout the World. The internal circuit board, components, design, firmware, software and operating features will not vary significantly from manufacturer to manufacturer of cellular phones, in as far as the end user is concerned. The only significant exception will be the cosmetic or physical shape of the module, which will vary from manufacturer to manufacturer in that it is designed to contour to the external plastic case or housing of the cellular phone, and will be of he same plastic composition, color and texture as the body of the phone itself. The various features of the plug in module will include am encryption module or ASIC I/C chip, a credit card magnetic stripe reader head, a smartcard acceptor slot, an infra-red port for communicating to a wireless printer or p/c, for purposes of printing a receipt or downloading and storing transaction records, a bar code reader for scanning bar codes possibly from a magazine article, brochure or other form of advertisement, and fingerprint reader device to positively identify the credit card user or customer.

When the cellular phone is used normally the credit card reader module may remain attached to the external data port of the cellular phone at all times, however the module will go into a standby mode, in order to reduce the power consumption on the cellular phone's battery, until such time as the credit card reader module is activated by the action of someone sliding a credit card through its' slot. Once there is a credit card swipe through the body of the credit card reader module, then the electronic components on the circuit board embedded within the credit card reader module will go to their full wake-up mode and process the credit card data as follows:

1) Magnetically stored credit card data is read from the credit card magnetic stripe tracks 1, 2, 3 and stored in the internal memory.

2) Stored credit card data is encrypted within the internal microprocessor unit utilizing a US Government Certified T-DES algorithm.

3) The encrypted card data is displayed on the LCD display of the phone unit.

4) The phone's LCD displays prompts the user to enter the dollar amount of the transaction and then press the SEND key.

5) The WAP application in the cellular phone unit creates an Internet Protocol Session (IP Session) with a credit card processing center and transfers the encrypted credit card data over the air through the Mobile Telephone Switch Office (MTSO) to the processor via a Private Frame Relay-Link from the MTSO to the processor's facility.

6) The processing center decrypts the data utilizing a server computer owned and operated by the manufacturer of the plug-in module.

7) The decrypted data is processed it the usual manner as to determining if the credit card is expired, stolen, or over it's credit limit, and the amount of the transaction is approved or declined as to the dollar amount of the current purchase being processed.

8) The resulting approval or decline is transferred to the cellular phone module via the in process WAP application utilizing the IP session protocols.

9) The results from the processor are displayed on the screen of the LCD, within the cellular phone via the WAP application.

10) The credit card approval session is ended and the credit card module circuitry goes into it's standby/sleep mode in anticipation of another credit card transaction.

11) By aiming the module's infra-red window at a portable printer and depressing the Print Key on the module, the stored information regarding the previous transaction is transferred by infra-red transmission to the printer for the purpose of issuing a receipt to the user or customer.

12) In the case of a magazine depicting an item of clothing or merchandise on sale, such as, an in-flight airline magazine, the user or customer can scan the barcode for that item, which will be stored within the internal memory of the Attachment Module and can be used to make purchases wirelessly by swiping a credit card to effect the purchase and complete the transaction.

13) In case the identity of the credit card user is unknown, the customer can positively identify himself/herself by either sliding their magnetic striped driver's license through the credit card slot or by passing their finger in front of the fingerprint reader lens on the side of the Attachment Module.

Once a driver's license or fingerprint data is read and stored, the data is encrypted utilizing the same encryption algorithm referred to herein above for the credit card captured data This then creates a secure portal, for all types of transactions, including but not limited to E-mail messages, financial transactions, and purchases utilizing a credit card, a debit card, a check, or other form of payment verification, and to pay traffic tickets at the side of the road.

### A BRIEF DESCRIPTION OF THE DRAWINGS

FIG. 1, depicts the exterior of the plug-in module and its contour to the cellular telephone to which it is attached.

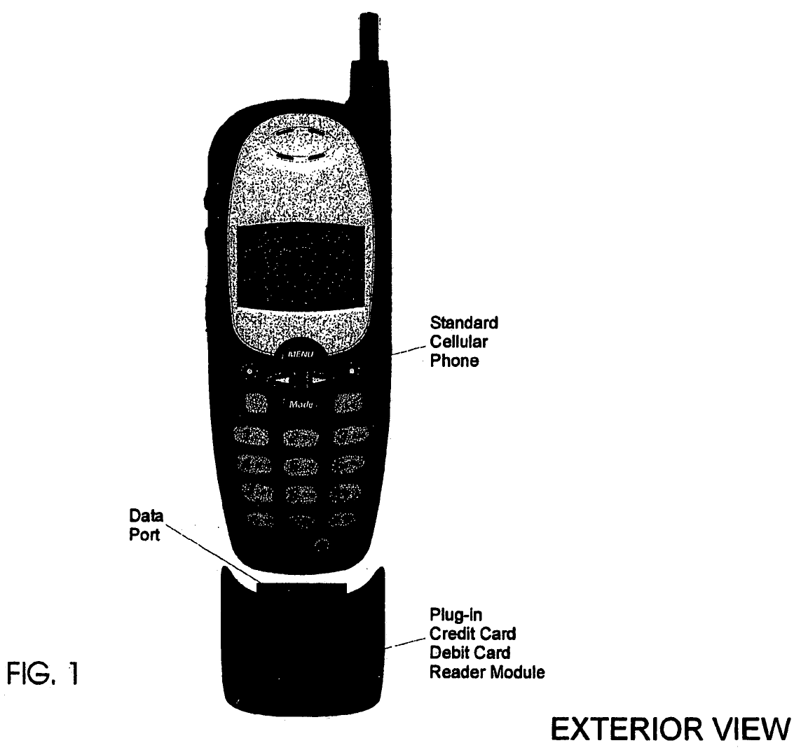

FIG. 2, depicts the internal component portioning of the circuit board and the various component parts within the module's internal cavity.

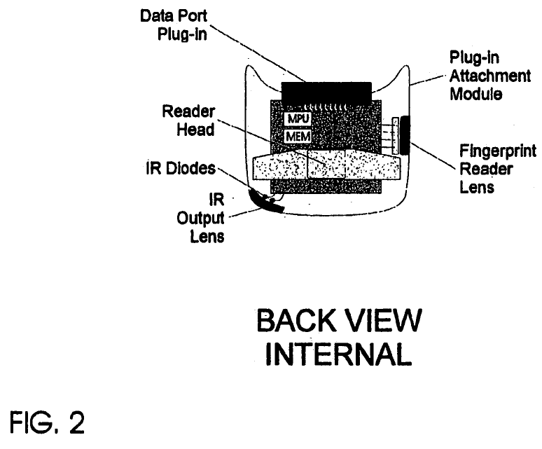

FIG. 3, depicts the flow of the credit card data as the transaction occurs.

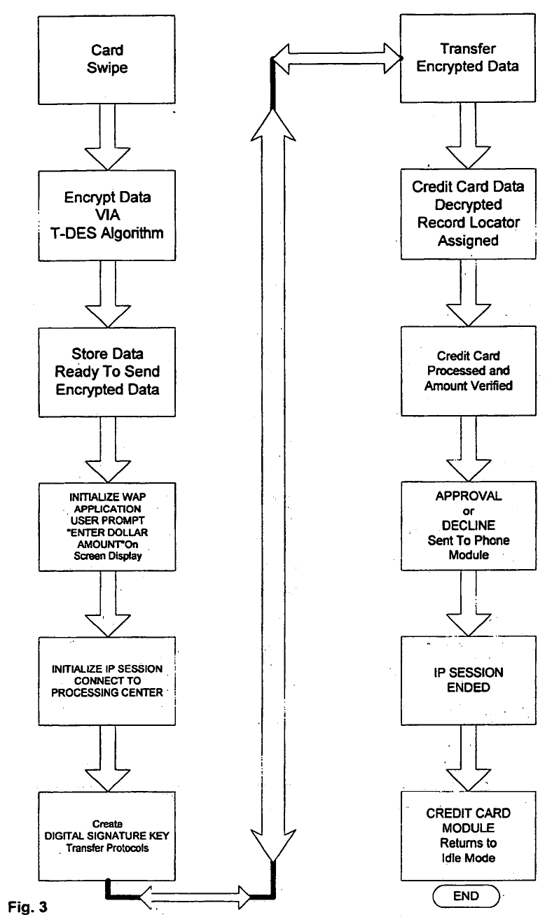

FIG. 4, depicts the entire system including, the cellular phone with attached module, the Mobile Telephone Switch Office, the Private Frame Relay connection to the Credit Card Processing Agency, the decryption server located at the processor's facility, the processing company's computer server and the processor's internal link to Visa-Net or American-Express or other credit card issuing agency's Ethernet hub Worldwide.

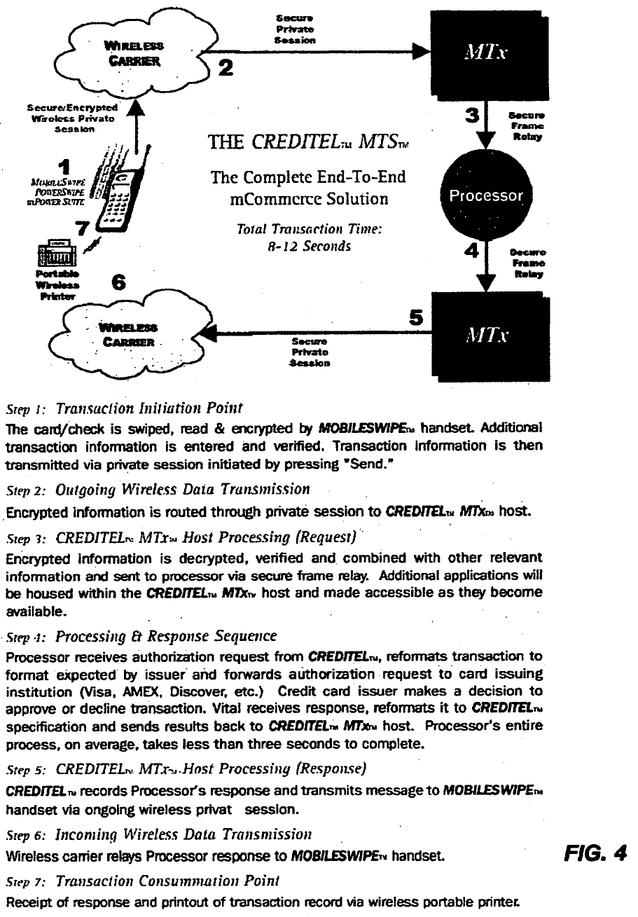

FIG. 5, depicts the encryption process and the subsequent decryption process from start to finish.

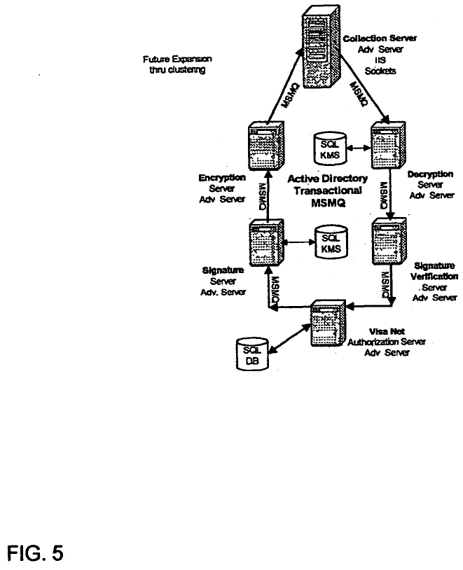

FIG. 6, depicts the manner in which the various organizations including the processing center, Settlement Bank, the cellular provider, the manufacturer of the cellular phone (for inventory control purposes), the module manufacturer, and the credit car issuing agency, whom all share common database in case of theft or loss of units, customer complaints or inquiries, and support for the various agencies' customer help and support desks.

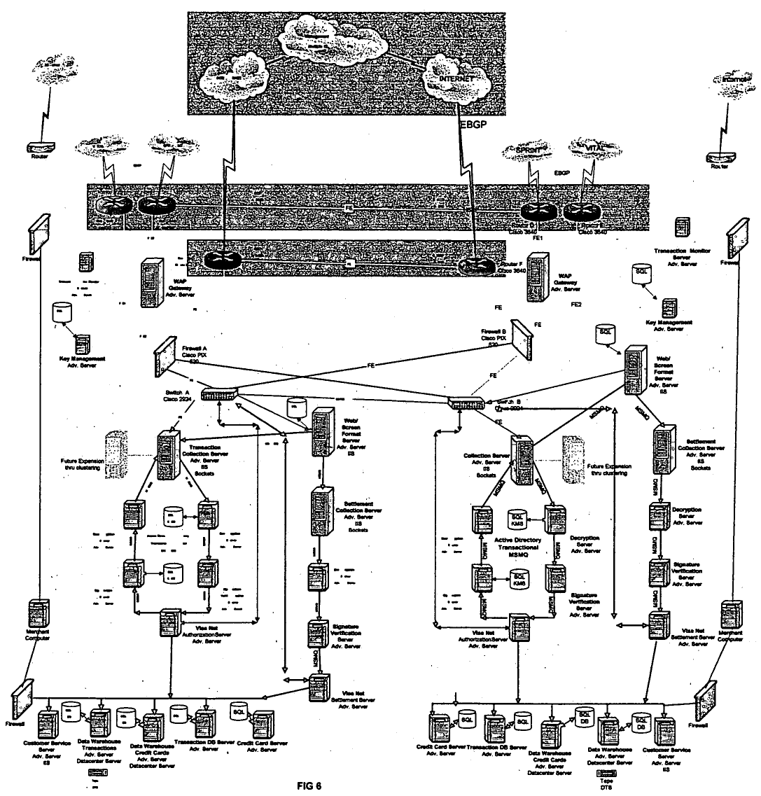

1. I claim, a plug-in attachment module for any manufactured cellular telephone as an after market device, which attaches to the unmodified off the shelf, hand-held cellular telephone, by connecting through the standard external data port, either via an RS-232 configuration, a USB configuration or a three-wire serial configuration, and said module to be comprised of and contain:
1. A credit card magnetic stripe reader head;
2. A Smartcard insertion slot;
3. A-barcode reader device;
4. A fingerprint reader device;
5. An I/R(infra-red) wireless printer of P/C interface (standard protocols);
6. A T-DES or AES type approved encryption module consisting of an ASIC part configured to receive input data unencrypted and output data in an NSA certified encryption standard, with internal pseudo random key generation encapsulated in a hardened epoxy resin.

2. I claim, all of the components in claim 1 above, with the exception that the plug-in module is tethered on a cable, which plugs into the external data port of the standard off the shelf hand-held cellular phone, and the module is glued, velcroved, or otherwise temporarily affixed to the side or back of the cellular phone, and can be removed at anytime by simply unplugging the cale and peeling off the card slot module from the velcrove adhesive.
The said module connects to a credit card processing center, a retail sales organization, a bill payment center, or an Internet sales organization, to effect purchases, pay bills, settle accounts and effect secure transmissions for financial transactions via a secure Internet portal, either via the Internet or via a private network. The secure session is accomplished by an IP session, dial-up session, or cellular overhead signaling and Messaging session.
